(19) United States
(12) Patent Application Publication
(10) Pub. No.: US 2010/0033976 A1
(43) Pub. Date: Feb. 11, 2010

(54) HEAT DISSIPATION MODULE FOR LIGHT EMITTING DIODE

(75) Inventors: MING-CHIH SUN, Tu-Cheng (TW); KAI HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/274,331

(22) Filed: Nov. 19, 2008

(30) Foreign Application Priority Data
Aug. 8, 2008 (CN) 200810303602.9

(51) Int. Cl. F21V 29/00

(52) U.S. Cl. 362/382

(57) ABSTRACT

A dissipation module for a light emitting diode includes a substrate, a printed circuit board, and a heat sink. The substrate has electrode sheets on which the light emitting diode is electrically mounted. The printed circuit board includes an upper surface and a bottom surface. The printed circuit board defines plated through holes passing from the upper surface to the bottom surface, and mounts on the substrate with the bottom surface in contact with the upper surface. The heat sink connects to the bottom surface of the printed circuit board through a conductive layer.

### BACKGROUND

1. Technical Field

The disclosure relates to heat dissipation modules and, particularly, to a heat dissipation module for a light emitting diode (LED).

2. Description of the Related Art

With ongoing technology development, light emitting diodes (LEDs) are becoming increasingly smaller and more powerful. Accordingly, dissipation of excess heat has become increasingly important to maintain LED reliability. Unfortunately, current LEDs are generally mounted directly on a printed circuit boards (PCB) made partially of material with high thermal resistance. As a result, the heat dissipation channel of the LEDs is blocked and efficiency of heat dissipation reduced. Reliability cannot thus be guaranteed.

Therefore, it is desirable to provide a heat dissipation module for an LED which can overcome the limitations described.

### BRIEF DESCRIPTION OF THE DRAWINGS

FIG. 1 is a schematic cross-sectional view of a first embodiment of a heat dissipation module for an LED.

FIG. 2 is a schematic cross-sectional view of a second embodiment of a heat dissipation module for an LED.

FIG. 3 is a schematic cross-sectional view of a third embodiment of a heat dissipation module for an LED.

### DETAILED DESCRIPTION OF THE EMBODIMENTS

The dissipation module is described in detail here with reference to the drawings.

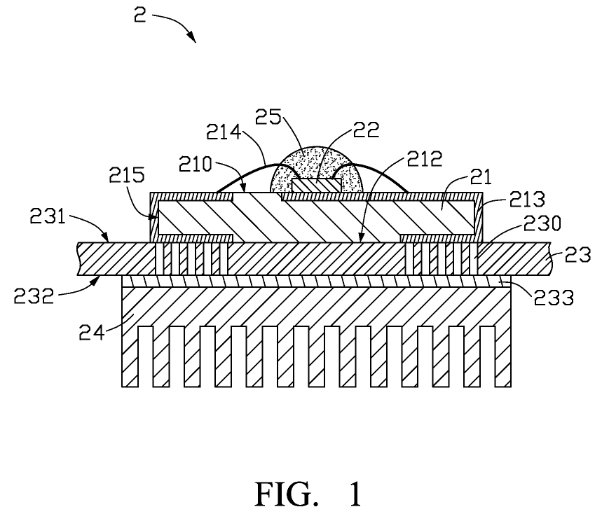

As shown in FIG. 1, a heat dissipation module 2 of a first embodiment includes a substrate 21, a light emitting diode (LED) 22, a printed circuit board (PCB) 23, a heat sink 24, and a transparent encapsulation layer 25. The LED 22 is disposed on the substrate 21 and is encapsulated by the transparent encapsulation layer 25.

The substrate 21 includes an upper surface 210, a bottom surface 212, and a lateral surface 215. Two electrode sheets 213 on the substrate 21 are connected from a part of the upper surface 210 to a part of the bottom surface 212 via a part of the lateral surface 215, respectively. The electrode sheets 213 are high-thermal conductive material. The LED 22 is mounted on the electrode sheets 213 of the upper surface 210 by glue and electrically connected thereto by conducting wires 214. The substrate 21 is electrically insulating ceramic material, which may be aluminum oxide (Al₂O₃), magnesium oxide (MgO), aluminum nitride (AlN), boron nitride (BN), silicon dioxide (SiO₂), or beryllium oxide (BeO).

The transparent encapsulation layer 25 is convex to collect light emitted by the LED 22 and is electrically insulating material such as epoxy resin or silicone. Moreover, the transparent encapsulation layer 25 can convert light of the LED 22 to other colors.

The PCB 23 includes an upper surface 231 and a bottom surface 232. The substrate 21, via the electrode sheets 213, is electrically mounted to the PCB 23 with the bottom surface 232 in contact with the upper surface 231. The PCB 23 defines a number of plated-through holes (PTHs) 230 passing from the upper surface 231 to the bottom surface 232 and electrically coupled to the electrode sheets 213. The PTHs 230 are electroplated with a conductive coating, such as copper (Cu), to increase conductive efficiency of the PCB 23.

The heat sink 24 is connected to the bottom surface 232 of the PCB 23 via a conductive layer 233. The conductive layer 233 can be metal material such as tin (Sn).

Heat generated by the LED 22 is efficiently conducted from the electrode sheets 213 to the conductive layer 233 via the PTHs 230 and is finally dissipated by the heat sink 24.

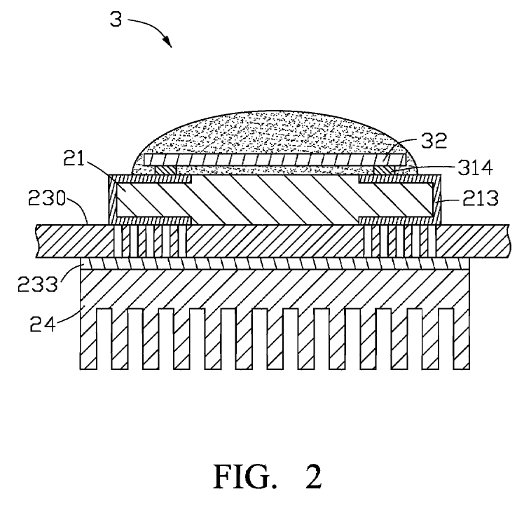

Referring to FIG. 2, a heat dissipation module 3 according to a second embodiment differs from the heat dissipation module 2 only in that a flip-chip LED 32 including solder balls 314 formed thereon is deployed rather than the LED 32 itself, which can, accordingly, be directly mounted on the substrate 21 with the solder balls 314 soldered to the electrode sheets 213, whereby no conductive wires are required. In operation, heat from the flip-chip LED 32 is efficiently transmitted to the solder balls 314, the electrode plates 213, the PTHs 230, the conductive layer 233, and finally the heat sink 24.

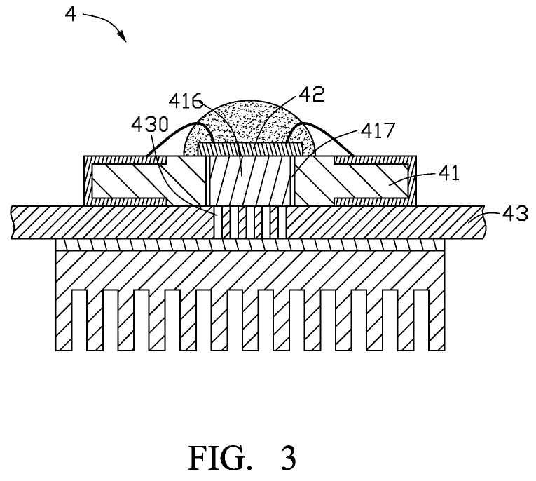

As shown in FIG. 3, a heat dissipation module 4, according to a third embodiment differs from heat dissipation module 2 only in that substrate 41 includes a through hole 417, with which LED 42, mounted to the substrate 41, is aligned. An insert 416 in the through hole 417 has upper and bottom surfaces respectively contacting the LED 42 and PCB 43. The insert 416 is highly conductive material, such as Cu. PTHs 430 are formed in the PCB 43, all or most thermally contacting the insert 416, thereby enhancing dissipation efficiency of the LED 42.

It will be understood that the above particular embodiments are described and shown in the drawings by way of illustration only. The principles and features of the disclosure may be employed in various and numerous embodiments thereof without departing from the scope of the invention as claimed. The above-described embodiments illustrate the scope of the invention but do not restrict the scope of the invention.

What is claimed is:

1. A heat dissipation module for a light emitting diode, comprising:
a substrate with electrode sheets thereon, on which the light emitting diode is mounted and electrically connected to the electrode sheets;
a printed circuit board comprising an upper surface and a bottom surface, defining plated through holes extending from the upper surface to the bottom surface and electrically connected with the electrode sheets, mounted on the substrate with a bottom surface of the substrate in contact with the upper surface; and
a heat sink connecting to the bottom surface of the printed circuit board through a conductive layer.

2. The heat dissipation module of claim 1, wherein the substrate comprises an upper surface, and a lateral surface; the electrode sheets run from a part of the upper surface to a part of the bottom surface of the substrate via a part of the lateral surface.

3. The heat dissipation module of claim 1, wherein the electrode sheets are high-thermal conductive material.

4. The heat dissipation module of claim 1, wherein the substrate comprises a through hole aligned with the light emitting diode.

5. The heat dissipation module of claim 4, wherein an insert received in the through hole has upper and bottom surfaces respectively contacting the light emitting diode and printed circuit board.

6. The heat dissipation module of claim 5, wherein the insert is made of highly conductive material.

7. The heat dissipation module of claim 6, the conductive material is copper.

8. The heat dissipation module of claim 1, wherein the substrate is partially made of insulating ceramic material.

9. The heat dissipation module of claim 8, wherein the insulating ceramic material is aluminum oxide, magnesium oxide, aluminum nitride, boron nitride, silicon dioxide or beryllium oxide.

10. The heat dissipation module of claim 1, wherein the light emitting diode is mounted to the substrate by glue.

11. A light emitting module, comprising:
a substrate forming electrode sheet thereon, the light emitting diode being mounting and electrically connected to the electrode sheets;
a printed circuit board comprising an upper surface and a bottom surface, defining plated through holes passing from the upper surface to the bottom surface and electrically connected with the electrode sheets, and mounting to the substrate with a bottom surface of the substrate in contact with the upper surface;
a heat sink connected to the bottom surface of the printed circuit board through a conductive layer; and
a transparent encapsulation layer encapsulating the light emitting diode.

12. The light emitting module of claim 11, wherein the substrate comprises a through hole aligned with the light emitting diode; an insert is inserted into the through hole and has its upper and bottom surface respectively contacted with the light emitting diode and printed circuit board.

13. The light emitting module of claim 11, wherein the substrate is partially made of insulating ceramic material.

14. The light emitting module of claim 13, wherein the insulating ceramic material is aluminum oxide, magnesium oxide, aluminum nitride, boron nitride, silicon dioxide or beryllium oxide.

15. The light emitting module of claim 11, wherein the conductive layer is made of metal.

16. The light emitting module of claim 15, wherein the metal is tin.
